(19) United States
(12) Patent Application Publication
(10) Pub. No.: US 2017/0286929 A1
(43) Pub. Date: Oct. 5, 2017

(54) METHOD AND SYSTEM FOR DIGITAL MONEY MANAGEMENT FOR A PAYMENT ACCOUNT

(71) Applicant: Mastercard International Incorporated, Purchase, NY (US)

(72) Inventors: Ryan P. BODMAN, Louisville, KY (US); Claudia Alexandra BARON-AOUDAL, New York, NY (US); Cynthia M. CHASTAIN, New York, NY (US); Thomas Robert CRONIN, Danbury, CT (US); Kevin John FINNEGAN, Yorktown Heights, NY (US); Eric Jon MCILWAIN, New York, NY (US); Kun WANG, Wilton, CT (US)

(73) Assignee: Mastercard International Incorporated, Purchase, NY (US)

(21) Appl. No.: 15/474,145

(22) Filed: Mar. 30, 2017

Related U.S. Application Data
(60) Provisional application No. 62/315,266, filed on Mar. 30, 2016.
(60) Provisional application No. 62/413,148, filed on Oct. 26, 2016.

(51) Int. Cl. G06Q 20/10; G06Q 40/02; G06F 17/30

(52) U.S. Cl. CPC G06Q 20/102; G06F 17/30312; G06Q 40/02

(57) ABSTRACT

A method for managing account savings via authorization holds includes: storing an account profile related to a transaction account including an account identifier and primary account number; receiving a savings request including the account identifier and savings data; identifying a starting amount, goal amount, and period of time based on the savings data; generating a first transaction message including the primary account number starting amount; transmitting the first transaction message to a financial institution associated with the related transaction account; generating a second transaction message including the primary account number and goal amount; and transmitting the second transaction message to the financial institution associated with the related transaction account after at least the period of time following transmission of the first transaction message.

### FIELD

The present disclosure relates to the management of money in one or more transaction accounts via a digital solution provided by a third party entity, specifically the use of a third party platform to enable a consumer to manage money in one or more transaction accounts across one or more financial institutions via a computing device, where management includes the specialized saving of money on legacy financial systems.

### BACKGROUND

As technology improves and consumers have greater and greater access to computing devices, consumers seek more and more technological solutions for activities in their daily lives. One industry that has seen a significant increase in the use of technological solutions for consumer interaction is the banking and finance industry. In this industry, as systems of banks and other financial institutions have improved, many have begun to offer consumers the ability to manage their accounts and finances via web sites and application programs accessed using computing devices. Such web sites and programs have seen a large amount of consumer usage, with consumers taking advantage of the greater accessibility to their finances using these tools.

However, in many instances, financial institutions use customized web sites and application programs that are specific to that institution and, in some instances, specific to particular products offered by that institution. For the large number of consumers that have financial products with multiple financial institutions, or even a large number of products with a single financial institution, this can be cumbersome. In such instances, the consumer must register separately for each product, maintaining separate credentials for each, and having to access a large number of web sites and application programs just to get an overall picture of their financial situation.

In an effort to ease the burden on consumers, some systems have been developed to assist the consumer in getting an overview of their finances. Such systems operate by collecting authentication credentials and other account information from a consumer for each transaction account or financial product they want to monitor, and by accessing these accounts and products with their respective financial institutions on behalf of the consumer, pulling their information and compiling it for the consumer's review. The result is that the consumer gets an overview of their overall financial situation with respect to every product and account they register.

However, such systems are often limited in that they provide nothing more than an overview of the consumer's situation. While such systems may provide the consumer with a broad look at their finances and may provide tools to help the consumer with financial decisions, these systems are often unable to assist the consumer with actual management of their accounts and products. Instead, the system provides the consumer with a suggested action, with the consumer having to go to the respective financial institution themselves and perform the action. As a result, the consumer is still required to maintain all of their credentials and to continually access the various web sites and application programs used in management of each of their transaction accounts and other financial products.

Thus, there is a need for a technical solution where a third party platform may be able to assist the consumer with not only monitoring of multiple transaction accounts and other financial products but also actual management of these accounts and products. Furthermore, some financial institutions may be limited in the management tools provided to consumers for their respective transaction accounts and products. In such instances, there is a further need for a technical solution where a third party platform can provide the user with additional management tools for managing a transaction account that may not be available in legacy financial systems.

### SUMMARY

The present disclosure provides a description of systems and methods for the management of account savings via authorization holds. The use of authorization holds may enable a consumer to manage savings in a transaction account where the legacy financial systems of the associated financial institution are unable to accommodate the saving of currency already deposited in the transaction account.

A method for managing account savings via authorization holds includes: storing, in an account database of a processing server, an account profile, wherein the account profile includes a standardized data set related to a transaction account including at least an account identifier and primary account number; receiving, by a receiving device of the processing server, a data signal superimposed with a savings request, wherein the savings request includes at least the account identifier and savings data; identifying, by a data identification module of the processing server, at least a starting amount, a goal amount, and a period of time based on the savings data; generating, by a generation module of the processing server, a first transaction message, wherein the first transaction message is formatted pursuant to one or more standards and includes a plurality of data elements including at least a first data element configured to store the primary account number and a second data element configured to store the starting amount; electronically transmitting, by a transmitting device of the processing server, the first transaction message to a financial institution associated with the related transaction account; generating, by the generation module of the processing server, a second transaction message, wherein the second transaction message is formatted pursuant to the one or more standards and includes a plurality of data elements including at least a first data element configured to store the primary account number and a second data element configured to store the goal amount; and electronically transmitting, by the transmitting device of the processing server, the second transaction message to the financial institution associated with the related transaction account after at least the period of time following transmission of the first transaction message.

A system for managing account savings via authorization holds includes: an account database of a processing server configured to store an account profile, wherein the account profile includes a standardized data set related to a transaction account including at least an account identifier and primary account number; a receiving device of the processing server configured to receive a data signal superimposed with a savings request, wherein the savings request includes at least the account identifier and savings data; a data identification module of the processing server configured to identify at least a starting amount, a goal amount, and a period of time based on the savings data; a generation module of the processing server configured to generate a first transaction message, wherein the first transaction message is formatted pursuant to one or more standards and includes a plurality of data elements including at least a first data element configured to store the primary account number and a second data element configured to store the starting amount; and a transmitting device of the processing server configured to electronically transmit the first transaction message to a financial institution associated with the related transaction account. The generation module of the processing server is further configured to generate a second transaction message, wherein the second transaction message is formatted pursuant to the one or more standards and includes a plurality of data elements including at least a first data element configured to store the primary account number and a second data element configured to store the goal amount. The transmitting device of the processing server is further configured to electronically transmit the second transaction message to the financial institution associated with the related transaction account after at least the period of time following transmission of the first transaction message.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for a third party platform for managing money in a plurality of transaction accounts and financial products in accordance with exemplary embodiments.

FIG. 2 is a block diagram illustrating the processing server of FIG. 1 for management of money in a plurality of transaction accounts and financial products including the management of savings in a legacy financial system in accordance with exemplary embodiments.

FIG. 3 is a flow diagram illustrating a process for managing account savings in a transaction account using authorization holds in a legacy financial system using the processing server of FIG. 2 in accordance with exemplary embodiments.

FIG. 4 is a flow chart illustrating an exemplary method for managing account savings via authorization holds in accordance with exemplary embodiments.

FIG. 5 is a flow diagram illustrating the processing of a payment transaction in accordance with exemplary embodiments.

FIG. 6 is a block diagram illustrating a computer system architecture in accordance with exemplary embodiments.

FIG. 7 is a diagram illustrating the identification of periods of time for use in identifying safe spending amounts for managing account spending in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Digital Money Management Via Third Party Platform

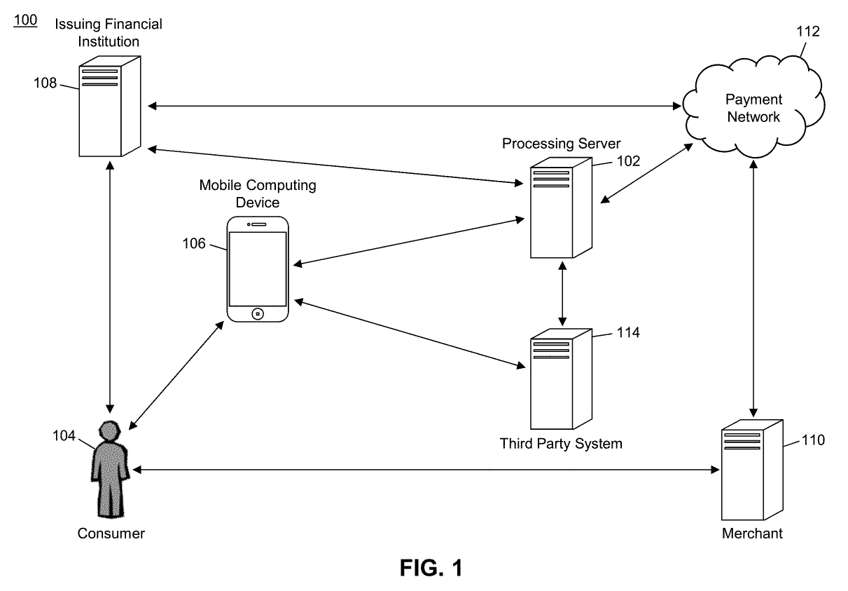

FIG. 1 illustrates a system 100 for the management of money or other forms of currency (herein collectively referred to as “money”) for consumer transaction accounts and other financial products via a third party platform accessed digitally via a computing device.

The system 100 may include a processing server 102. The processing server 102, discussed in more detail below, may be configured to provide a platform to a consumer 104 for management of transaction accounts and other financial products. The platform may be accessible to the consumer 104 via a mobile computing device 106 or other suitable type of computing device. The mobile computing device 106 may be, for example, a laptop computer, notebook computer, tablet computer, cellular phone, smart phone, smart watch, wearable computing device, implantable computing device, etc. Additional computing devices that may be suitable for accessing the platform provided by the processing server 102 may include, for example, a desktop computer, smart television, smart appliance, etc. The mobile computing device 106 may access the platform via a web site, application program stored locally on the mobile computing device 106 or externally to the mobile computing device 106 and executed thereby, or other suitable method that will be apparent to persons having skill in the relevant art.

The consumer 104 may be issued a transaction account or other financial product from an issuing financial institution 108. The issuing financial institution 108 may be a bank or any other financial institution configured to issue transaction accounts or other financial products to a consumer 104. Transaction accounts may include debit accounts, credit accounts, savings accounts, checking accounts, or other accounts that may be used to fund or receive money in payment transactions. Other financial products may include, for example, retirement accounts, mortgages, loans, investment accounts, trusts, or any other product that may be issued or otherwise managed by an issuing financial institution 108 related to the banking and finance industry.

As part of the issuing of a transaction account or other financial product to the consumer 104, the consumer 104 may register an account with the respective issuing financial institution 108 suitable for accessing the transaction account or product using a suitable electronic communication method, such as via a web site or application program. The registration may include the establishing of authentication credentials for use in the accessing of the transaction account or other financial product.

The consumer 104 may register with the processing server 102 to utilize the platform provided by the processing server 102 for management of the consumer's finances. The registration process may include the providing (e.g., via the mobile computing device 106 using the web site, application program, or other method of accessibility to the platform) the authentication credentials for each transaction account or other product the consumer 104 would like the processing server 102 to monitor and manage. The consumer 104 may provide authentication credentials for a single transaction account or financial product, for multiple accounts or products issued by a single issuing financial institution 108, a single transaction account or product issued by each of a plurality of different issuing financial institutions 108, or a plurality of transaction accounts and/or other financial products issued by a plurality of different issuing financial institutions 108.

The processing server 102 may store the authentication credentials for each transaction account or financial product and information identifying the corresponding issuing financial institution 108 in a profile associated with the consumer 104 and the mobile computing device 106. The processing server 102 may use the authentication credentials in accessing and managing the respective transaction accounts or other financial products with the corresponding issuing financial institutions 108. For example, to retrieve data associated with a transaction account, the processing server 102 may electronically transmit a data signal to the issuing financial institution 108 that is superimposed or otherwise encoded with a data request that includes the authentication credentials. The data signal may be electronically transmitted via a suitable communication network and method, such as via the Internet. The issuing financial institution 108 may authenticate the processing server 102 as an authorized entity for accessing the consumer's registered transaction account or other financial product, and may return the requested data to the processing server 102 via another electronic transmission. In some instances, communications between the processing server 102 and an issuing financial institution may utilize one or more application programming interfaces (APIs).

Data that may be captured for the transaction accounts and other financial products managed via the platform of the processing server 102 may include data related to payment transactions involving the consumer 104. The consumer 104 may conduct payment transactions with a plurality of different merchants 110. As part of the conducting of payment transactions, the consumer 104 may furnish payment credentials to a merchant 110 that are associated with the transaction account issued by the issuing financial institution 108 for use thereby. Payment credentials may include, for example, a primary account number associated with the corresponding transaction account and other data that may be used in the processing of a payment transaction funded by the corresponding transaction account, such as a transaction counter, one or more cryptograms, a personal identification number, etc. Payment credentials may be provided to the merchant 110 using any suitable method, such as via a physical payment card having payment details encoded thereon and read by the merchant systems, display of a machine-readable code encoded with payment details read by the merchant systems, electronic transmission of payment details from a computing device of the consumer 104 (e.g., the mobile computing device 106) to the merchant systems, such as using near field communication, etc.

The merchant 110 may submit the payment details along with other transaction details to a payment network 112 for processing of the payment transaction. The transaction details may be electronically transmitted to the payment network 112 directly by the merchant 110 or via one or more intermediate entities, such as an acquiring financial institution, gateway processor, etc. The transaction details may be electronically transmitted to the payment network 112 via payment rails associated therewith, and may be included in a transaction message generated by the merchant 110 or an intermediate entity.

The transaction message may be a specially formatted data message that is formatted pursuant to one or more standards governing the exchange of financial transaction messages, such as the International Organization of Standardization's ISO 8583 or ISO 20022 standards. A transaction message may include a message type indicator indicative of a type of the transaction message, such as an authorization request for transaction messages received by the payment network 112 that require processing. A transaction message may also include a plurality of data elements, where each data element may be configured to store transaction data, such as data elements configured to store a transaction time, a transaction date, a transaction amount, a geographic location, a merchant identifier, a primary account number, product data, merchant data, offer data, loyalty data, reward data, point of sale data, issuer data, acquirer data, currency data, etc. In some instances, a transaction message may also include one or more bitmaps, where each bitmap may indicate the data elements included in the transaction message and the transaction data stored therein.

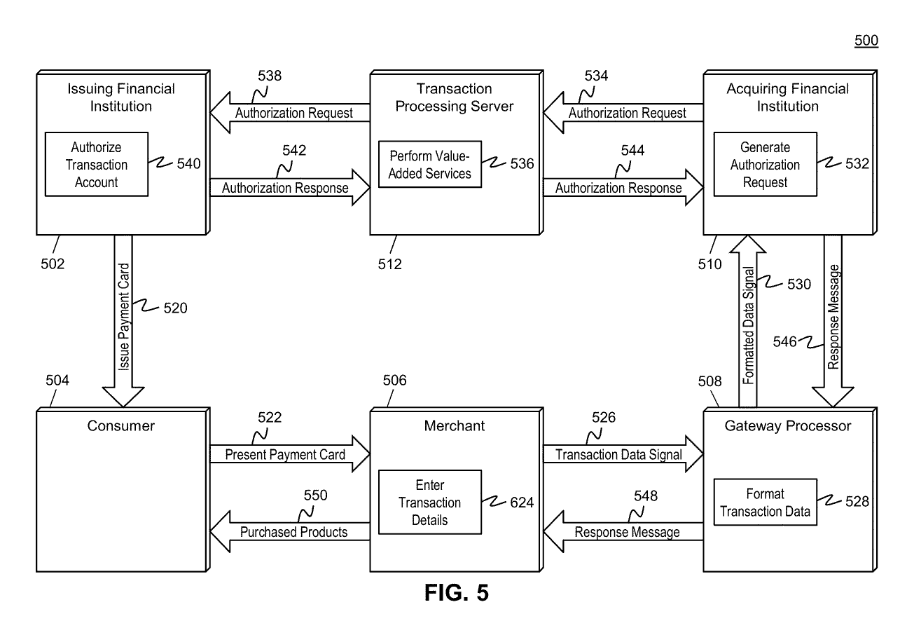

The payment network 112 may receive the transaction message and may process the payment transaction using traditional methods. Such methods may include, for example, performing any value-added services for the issuing financial institution 108, such as transaction scoring, swapping of account identifiers, etc., and forwarding the transaction message to the issuing financial institution 108 via the payment rails associated therewith for approval or denial. The issuing financial institution 108 may return a transaction message to the payment network 112 indicating the approval or denial via the payment rails associated therewith, and the payment network 112 may finalize the transaction, such as by indicating to the merchant 110 if the transaction was approved or denied. Additional detail regarding the use of transaction messages and the processing of payment transactions via a payment network 112 is discussed below with respect to the process 500 illustrated in FIG. 5.

The processing server 102 may receive transaction data for the payment transactions conducted by the consumer 104 using transaction accounts registered with the processing server 102. In some instances, the processing server 102 may receive the transaction data from the issuing financial institution 108, such as may be captured during the processing of the payment transaction. In other instances, the processing server 102 may receive the transaction data directly from the payment network 112, such as in instances where the issuing financial institution 108 and/or consumer 104 may authorize the processing server 102 to directly receive the transaction data, and/or in instances where the processing server 102 may be a part of the payment network 112 and may capture the transaction data during the processing of the payment transaction, such as may be identified via information provided by the consumer 104 and/or issuing financial institution 108 during registration, such as a primary account number. The processing server 102 may store the transaction data locally in an account profile associated with the consumer 104 as transaction data entries or transaction messages.

The processing server 102 may be configured to provide a plurality of services to the consumer 104 for registered transaction accounts and financial products. One service may include the management of savings in a transaction account registered by the consumer 104. For example, the consumer 104 may have a single transaction account with an issuing financial institution 108 that may have a legacy financial system not capable of providing multiple “purses” or other means of storage or other demarcation of the funds accessible by the transaction account. As such, the issuing financial institution 108 may be unable to provide the consumer 104 with a solution for managing savings in the transaction account that are not readily accessible. The consumer 104 may use the mobile computing device 106 to access the platform provided by the processing server 102 and may submit a savings request thereto. The savings request may be superimposed or otherwise encoded in a data signal electronically transmitted by the mobile computing device 106 to the processing server 102 via a suitable communication network and method.

The processing server 102 may receive the savings request from the mobile computing device 106. The savings request may identify the transaction account for which the consumer 104 wants to manage savings, and may also include savings data. The savings data may include data suitable for use by the processing server 102 in identifying a savings scheme for the consumer 104. The savings data may include, for example, a target savings amount and a period of time for reaching that amount, an initial saving amount, a savings goal, and a daily or incremental addition amount, etc. The processing server 102 may identify, using the savings data, at least an initial saved amount, a period of time, and a goal savings amount.

The processing server 102 may generate a transaction message to place an authorization hold for the initial saved amount on the transaction account for which the consumer 104 wants to manage savings. The transaction message may include a message type indicator indicating an authorization request and include a plurality of data elements including at least a data element configured to store a primary account number associated with the indicated transaction account, a data element configured to store the initial saved amount, and additional data elements configured to store any additional transaction data necessary for the placement of the authorization hold, such as a transaction time, transaction date, geographic location, issuer data, etc. The processing server 102 may submit the transaction message to the payment network 112, which may use traditional methods for processing the transaction message, including forwarding the transaction message to the issuing financial institution 108.

The issuing financial institution 108 may receive the transaction message and may place an authorization hold on the transaction account based on the data stored in the data elements included therein, including placing the authorization hold on an amount corresponding to the initial saved amount stored in the corresponding data element. The issuing financial institution 108 may return a transaction message having a message type indicator indicative of an authorization response and having a data element configured to store a response code indicating approval to the payment network 112, which may return the authorization response or an indication of approval to the processing server 102.

The authorization hold may then remain on the transaction account until the processing server 102 submits a clearing record to clear the payment transaction or until a predetermined period of time has passed, where such predetermined period of time may be set by the issuing financial institution 108, such as based on industry standards. The processing server 102 may be configured to maintain the authorization hold (e.g., by submitting new authorization requests if the authorization hold expires) until the consumer 104 cancels the savings or the savings amount is to be updated.

When the savings is cancelled, or the amount is updated, the processing server 102 may submit a clearing record to the payment network 112 that references the earlier authorization request, such as using a transaction identifier or other suitable identification value, that indicates that the transaction is to be cancelled or otherwise cleared for a zero amount. The payment network 112 may inform the issuing financial institution 108 accordingly, which may remove the authorization hold on the saved amount in the transaction account. In instances where the savings is to be cancelled, the processing server 102 may not perform any additional functions with respect to the transaction account, and may notify the consumer 104 of the clearing of the authorization hold, such as via a message electronically transmitted to the mobile computing device 106 and/or accessed thereby.

In instances where the saved amount is to be updated, the processing server 102 may generate and submit a new authorization request for the updated amount. This may result in the issuing financial institution 108 placing a new authorization hold on the transaction account for the updated amount. The processing server 102 may thus accommodate the usage of or contribution to the savings by the consumer 104 over time, where the savings may not be accidentally used in transactions involving the transaction account due to the authorization hold. Contributions may be made by the consumer 104 to the savings in any suitable manner. For instance, in a first example, the savings may be automatically contributed to daily by the consumer 104 from the same transaction account or from a different transaction account (e.g., where funds would be transferred to the transaction account using traditional methods, and the authorization hold updated accordingly). For instance, the consumer 104 may save $100 via a first transaction account, which may be saved through the use of an authorization hold initiated by the processing server 102. The consumer 104 may choose to transfer another $100 from a different account to add to the savings. The processing server 102 may initiate the transfer and, once the transfer is completed, cancel the first authorization hold and initiate a new authorization hold for $200.

In a second example, the savings may be contributed to at the behest of the consumer 104, via a request submitted to the processing server 102 via the mobile computing device 106. In such an example, the processing server 102 may cancel the first authorization hold (e.g., clear the authorization with a zero transaction amount) and initiate a second authorization hold for the initial savings amount plus the new contribution. In a third example, the savings may be contributed to in each transaction conducted by the consumer 104 using the transaction account. For instance, the processing server 102 may receive transaction data for each payment transaction conducted via the transaction account, may round the transaction amount up to the nearest even dollar amount, and may add the difference between the rounded amount and the transaction amount to the savings via a new authorization hold. In such an example, the processing server 102 may clear the existing authorization hold once a transaction is completed, and initiate a new authorization hold with the difference added to the savings. In some such instances, the processing server 102 may add up the difference amounts and initiate a new authorization hold periodically, such as a daily update to the savings based on all transactions conducted that day.

The use of an authorization hold may thus enable the providing of savings to a consumer 104 in a legacy financial system where the savings may be accomplished with a single transaction account without the use of additional purses or other demarcations that may be unavailable via the issuing financial institution 108. The use of an authorization hold may place the corresponding amount of money in a hold that makes it unavailable for use by the consumer 104. As such, that amount of money, the savings, will remain held until it reaches the goal amount or is otherwise cancelled by the consumer 104. The authorization hold may be updated by the processing server 102 via the use of clearing records and additional authorization requests, which may enable the continual update and modification of the saved amount without modification to the financial systems of the issuing financial institution 108, allowing the consumer 108 to have full control of a savings within their transaction account. In instances where the transaction account may be a credit account, the savings may be represented by an amount of the credit limit that is “saved” and is not usable via the authorization hold. In such an instance, a consumer 104 that may be in the habit of using their entire credit limit may use the processing server 102 to save a portion of the limit to use for a specific savings goal.

In some embodiments, the processing server 102 may determine services to provide to the consumer 104 based on information provided during the registration with the platform. For example, registration may include the filling out of a questionnaire by the consumer 104, where the questions are designed to identify the financial goals of the consumer 104 and the features they would like to use. For instance, the questions may identify that the consumer 104 wants to be able to establish a savings, for which the processing server 102 may provide the ability to establish savings in registered transaction accounts using authorization holds.

In one embodiment, the processing server 102 may be configured to identify an available spending amount for usage by the consumer 104. The available spending amount may be based on cash flow in and out of each of the registered transaction accounts, and may also be based on data provided by the consumer 104 in registration, such as an indication of income and expected expenditure amounts. In such embodiments, the processing server 102 may provide the available spending amount to the consumer 104 via the platform and may update the available spending amount as the consumer 104 spends. In some cases, the available spending amount may be an amount after regular and/or necessary expenditures by the consumer 104. For example, the available spending amount may be after rent and monthly bills paid by the consumer 104 and may be updated when transactions are conducted that are not for the payment of rent or monthly bills.

In some embodiments, the processing server 102 may be configured to establish multiple savings for the consumer 104 for a single transaction account or for one or more savings for the consumer 104 for multiple transaction accounts. In such embodiments, multiple authorization holds may be placed on a single transaction account, or funds may be transferred across transaction accounts and an authorization hold placed on the account to which funds were transferred. In such cases, the consumer 104 may be able to use names, descriptions, icons, or other indicators to differentiate savings plans for management thereof. In some instances, the processing server 102 may electronically transmit notifications to the mobile computing device 106 when the consumer 104 has available spending amounts due to a lack of spending or a lowering in expenses (e.g., the consumer 104 spent less on groceries in a given month or had a lower utility payment) to prompt for adding of the available spending amount to an established savings. This may, as a result, encourage the contribution of excess money by the consumer 104 to their savings, to foster smarter saving behavior.

In some embodiments, the processing server 102 may be configured to initiate payment transactions from the consumer 104 to other consumers. In such embodiments, the consumer 104 may access the platform using the mobile computing device 106 and may indicate another consumer to transfer money to, and may input an amount to transfer. In some cases, the processing server 102 may indicate the available spending amount to the consumer 104 for use in selecting the amount for transfer. In such cases, the consumer 104 may be made aware of the amount of money they have available to ensure they are not overspending. The processing server 102 may then initiate a payment transaction for the indicated amount to the indicated other consumer. In instances where the consumer 104 may have registered multiple transaction accounts, the consumer 104 may also indicate the transaction account to be used for the transfer, with the processing server 102 initiating the payment transaction from the indicated transaction account using registered payment credentials.

In some embodiments, the processing server 102 may also be configured to identify potentially fraudulent transactions. The processing server 102 may receive transaction data for a payment transaction conducted using a registered transaction account and may use traditional methods and systems to identify if the payment transaction may be fraudulent. In instances where the consumer 104 has registered multiple transaction accounts, the processing server 102 may utilize transaction data for past payment transactions in the other registered transaction accounts to provide for a more accurate and comprehensive determination regarding the likelihood of fraud that may be unavailable for the issuing financial institution 108 involved in the payment transaction. The processing server 102 may provide the determination to the issuing financial institution 108 or directly to the consumer 104, to provide the consumer 104 with an opportunity to dispute the payment transaction using traditional methods.

In an example, the consumer 104 may have two transactions accounts, each held by a different issuing financial institution 108. The consumer 104 may register both transaction accounts with the processing server 102, where the processing server 102 may collect transaction data for both transaction accounts from the payment network 112 and/or the respective issuing financial institutions 108. In the example, the consumer 104 may use the first transaction account to make several purchases in a first geographic location, such as near their home. The consumer 104 may purchase a train ticket using the second transaction account (e.g., due to better rewards for travel spending) and may immediately travel to a distance location using the ticket. The consumer 104 may then use the first transaction account again for a purchase. In traditional systems, the last purchase may be flagged for likelihood of fraud, due to the consumer 104 being in a new geographic location, unbeknownst to the issuing financial institution 108 associated with the first transaction account. In the system 100, the processing server 102, having transaction data for both accounts, may be able to verify the travel plans of the consumer 104 via the transaction conducted using the second transaction account, to determine a low likelihood of fraud for the last purchase. As a result, the issuing financial institutions 108 may receive more accurate fraud information, and the consumer 104 may transact more freely with any of their registered transaction accounts.

The processing server 102 may also be configured to enable the consumer 104 to split payments with additional consumers 104 or among multiple transaction accounts registered with the platform. In such embodiments, the consumer 104 may register a transaction account for use in split payment transactions, which may be split with other transaction accounts registered by the consumer 104 or with transaction accounts registered by other users of the platform provided by the processing server 102. In latter instances, the consumer 104 may indicate the other users, and the processing server 102 may communicate with the other users (e.g., via their respective registered mobile computing devices 106) for confirmation of the other users in participation of the split payment transactions and, if applicable, selection of a transaction account for usage therewith. Split payment transactions may be conducted where the transaction amount may be paid by each of the registered transaction accounts in an equal proportion or other proportion as may be designated by the consumer 104 and other users. In some instances, a group of transaction accounts may be established for split payment for a plurality of transactions, such as for selection for the split of future payment transactions or for the regular splitting of regularly occurring transactions, such as a rent or utility bill shared among roommates.

In some embodiments, the processing server 102 may be configured to assist the consumer 104 in providing a social impact. In such embodiments, the processing server 102 may provide the consumer 104 with tools for donating to impactful causes and/or for transacting with merchants having a beneficial social impact. For instance, in a first example, the processing server 102 may notify when the consumer 104 has available spending and may prompt the consumer 104 to donate the excess amount to a worthy cause, which may be selected by the consumer 104 or by the processing server 102. The entity to which the donation is to be made may be selected by the consumer 104 or by the processing server 102 at the time of the donation or prior to the donation (e.g., as previously selected by the consumer 104, such as a default entity), and may be made based on previous information collected from the consumer 104, such as during registration, such as suitable entities, interested causes, etc. In another example, the consumer 104 may establish regular contributions to a cause or associated entity using the same methods in the establishing of contributions to a savings using the processing server 102.

In another example, the processing server 102 may be configured to provide the consumer 104 with details associated with merchants 110 that support a cause indicated by the consumer 104 or that otherwise have a positive social impact. The consumer 104 may then choose to transact with such a merchant 110 to increase their social impact. For instance, in an example, the consumer 104 may use the platform to identify a merchant 110 that sells a particular product that the consumer 104 is interested in. The processing server 102 may identify merchants 110 that sell the product that have a positive social impact and may provide the list of merchants 110, and their positive impact, to the consumer 104. In such embodiments, the processing server 102 may also be configured to track the consumer's social impact based on their donations and spending with impactful merchants 110. Such data may be made available to the consumer 104 via the platform, such that the consumer 104 may be able to identify their own social impact and identify changes in their impact based on their spending habits.

In some embodiments, the system 100 may also include a third party system 114. The third party system 114 may be a computing system associated with a third party entity configured to provide additional services to the processing server 102 and/or the consumer 104 via the mobile computing device 106. The third party system 114 may be, for example, a system associated with an entity configured to provide savings analytics, which may be delivered to the consumer 104 via the mobile computing device 106 and may be used by the consumer 104 in their creation, use, and management of savings goals via the platform provided by the processing server 102. In such an example, the third party system 114 may be configured to receive data from the processing server 102 for use, such as transaction data, via electronic transmissions therefrom using a suitable communication network and method, and may provide data to the processing server 102 and/or directly to the mobile computing device 106. In some instances, data provided to the third party system 114 may be anonymized, such that the third party system 114 may provide metrics to the processing server 102 for delivery to the mobile computing device 106, without the third party system 114 being aware of the consumer 104 or the mobile computing device 106 to which they relate. Additional third party entities may include, for instance, loyalty program providers, advertising agencies, offer distributors, research firms, etc.

In some embodiments, the processing server 102 may be configured to identify safe spending amounts for the consumer 104 for their transaction account. A safe spending amount may be an amount available for the consumer 104 to spend that is an excess of their income over their expenses for a given period of time. The processing server 102 may be configured to identify an excess amount of currency available to the consumer 104 at the present time as well as at one or more future periods of time based on expected income and expenses, where the safe spending amount may be the lowest excess amount identified for each of the periods. For example, the consumer 104 may currently have $1000 in their transaction account, with $800 in known expenses to be incurred before their next paycheck. For a first period, between the present time and their next paycheck, the consumer 104 may have $200 in excess currency over their expenses. The consumer 104 may receive a paycheck every two weeks for $400 each, but may be incurring an expense of $500 after the first paycheck, and $450 after the second paycheck. For the second period, between the two paychecks, the consumer 104 may thus have $100 in excess currency. For a third period, after the second paycheck and before thirty days from the present date, the consumer 104 may only have $50 in excess currency (e.g., due to $1800 in income and $1750 in expenses). As a result, the consumer's true safe spending amount may be only $50, rather than the $200 that appears to be safe for the consumer 104 to spend at the present time.

As a result, the processing server 102 may be able to accurately identify the amount a consumer 104 is safe to spend that is based on the future position of the consumer 104, such that a consumer's present spending will not unknowingly put them in a negative position later on. In the above example, the processing server 102 utilized an overall thirty day period for identifying excess amounts, which was broken into multiple periods based on dates on which the consumer was to receive a paycheck. In some cases, the periods utilized by the processing server 102 may vary. For instance, the processing server 102 may use an overall period of a predetermined number of periods that are identified via paycheck dates, such as a total of three pay periods for the consumer 104. In another example, the processing server 102 may use an overall period of a predetermined number of time (e.g., thirty days, one month, etc.) that is broken up into periods of predetermined length (e.g., ten or fifteen day periods). In some cases, the periods or overall period may vary. For example, the processing server 102 may utilize an overall thirty day period that will encompass the receipt of two paychecks, but may have to extend the thirty day period in cases where two paychecks may not be received during a specific thirty day time. In such cases, the thirty day period may be extended to cover the two paychecks for that instance, and may revert back to a thirty day period for ongoing safe spending amount identifications.

In some instances, the processing server 102 may be configured to consider multiple sources of income for the consumer 104 when identifying the safe spending amount. For example, the consumer 104 may work two different jobs, or may receive regular income from an additional source (e.g., investments, alimony, child support, freelance work, etc.). In such instances, the processing server 102 may have separate periods in between each instance of income, where the income received may vary based on the associated source. In these instances, the processing server 102 may utilize the expected income and any expenses incurred prior to the receipt of the income to identify the excess amount for that respective period.

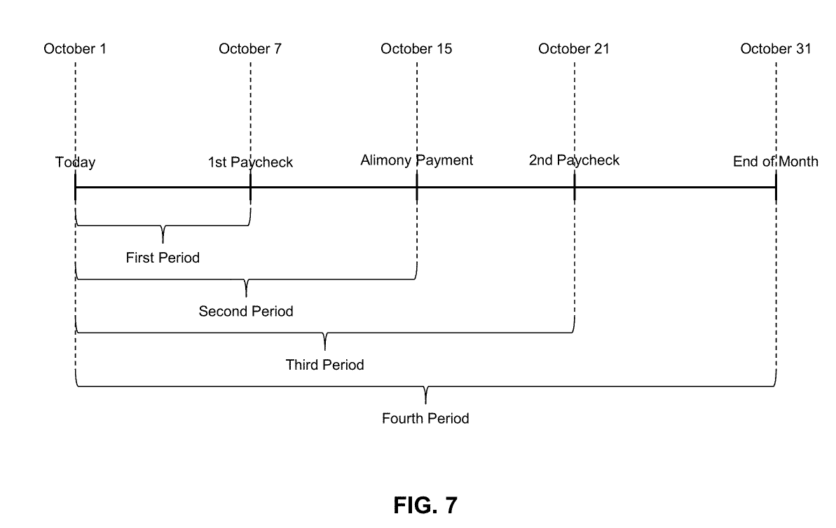

FIG. 7 illustrates an example for the identification of periods in instances where multiple sources of income may be received. In the illustrated example, the consumer 104 may have $1000 in their transaction account as of the first of the month. The processing server 102 may identify the consumer's safe spending amount over the course of the next thirty-one days in the month, where the consumer 104 is expected to receive paychecks of $500 on the 7th and 21st, and an alimony payment of $600 on the 15th. The processing server 102 may thus identify four periods: the 1st through the 7th, when the first paycheck is received; the 7th through 15th, when the alimony payment is received; the 15th through 21st, when the second paycheck is received; and the 21st through 30th, when the overall thirty day period ends. The expenses for the consumer 104 may be as follows: rent of $750 due on the 5th, utilities of $400 due on the 10th, a car payment of $800 due on the 20th, and taxes of $300 due on the 25th. The processing server 102 may thus identify the following excess amounts for each period: $250 for the first period, $350 for the second period, $150 for the third period, and $350 for the fourth period. As such, the safe spending amount for the consumer 104 for the next thirty days may be $150, as it is the lowest excess amount for the identified periods. By spending no more than the $150, the consumer 104 can ensure that they will have a positive balance throughout the thirty day period, regardless of when income is received or expenses are due.

The methods and systems discussed herein may enable the processing server 102 to provide consumers 104 with a third party platform useful in the management of transaction accounts and other financial products that provides tools that go beyond those available using traditional financial systems. In addition, the methods and systems discussed herein may also provide tools to consumers 104 for management of transaction accounts that are not possible using traditional financial systems, such as the establishing and management of savings in a transaction account via the technological solution of using authorization holds, which may be used in conjunction with legacy financial systems. As a result, the processing server 102 may provide for a technological solution to provide for additional technical features to a consumer 104 not available via existing financial systems, including in the management of multiple transaction accounts across a plurality of issuing financial institutions 108.

### Processing Server

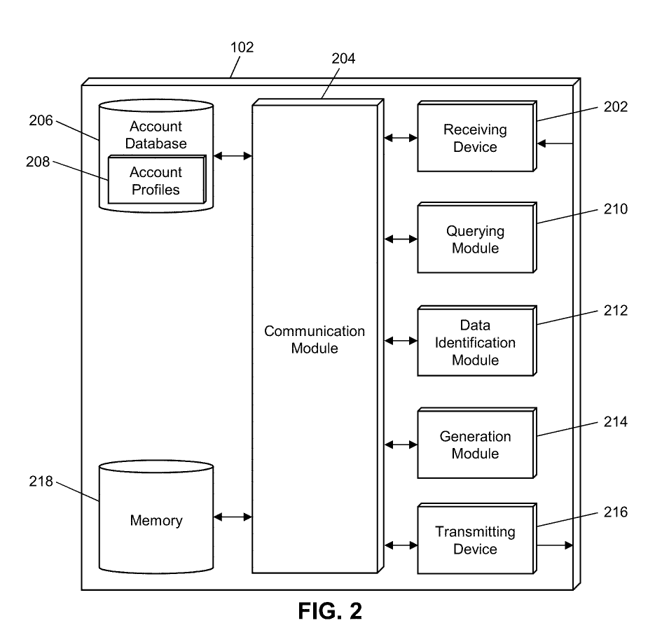

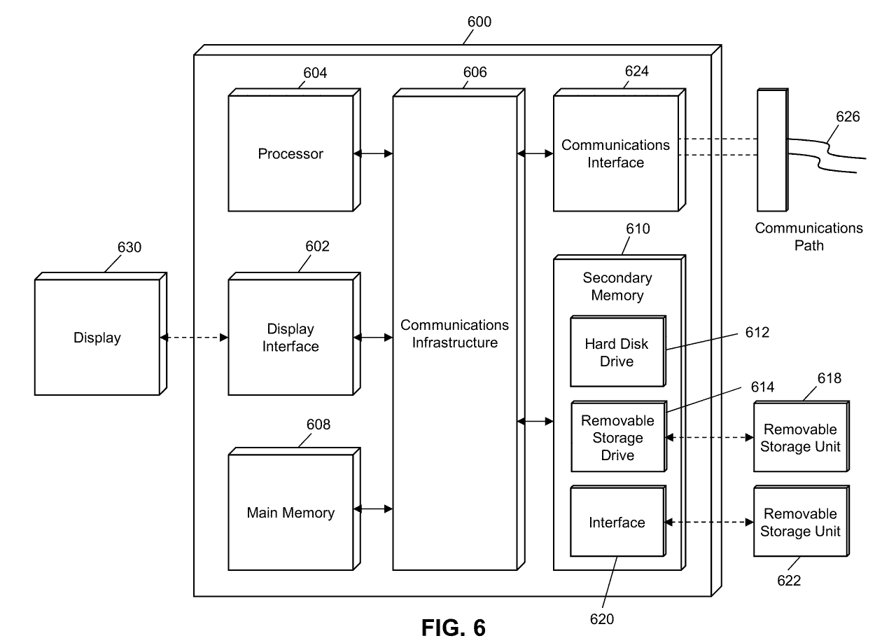

FIG. 2 illustrates an embodiment of a processing server 102 of the processing system 102 in the system 100. It will be apparent to persons having skill in the relevant art that the embodiment of the processing server 102 illustrated in FIG. 2 is provided as illustration only and may not be exhaustive to all possible configurations of the computing systems 200 of the processing system 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 112 for the transmission of transaction messages that include sensitive financial data and information. In some instances, the receiving device 202 may also be configured to receive data from mobile computing devices 106, issuing financial institutions 108, payment networks 112, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by payment networks 112 via payment rails associated therewith that may be superimposed or otherwise encoded with transaction messages. Transaction messages may be formatted pursuant to one or more standards, such as the ISO 8583 or 20022 standards, and include a message type indicator and a plurality of data elements, such as data elements configured to store primary account numbers, transaction amounts, merchant identifiers, transaction times and/or dates, device identifiers, and additional transaction data. In some instances, transaction data may be formatted in alternative data messages, which may be received via the payment rails associated with the payment network 112 or a suitable alternative communication network. The receiving device 202 may also be configured to receive transaction message or other alternative data messages for payment transactions from one or more issuing financial institutions 108 using suitable communication networks and methods. The receiving device 202 may be further configured to receive data signals electronically transmitted by mobile computing devices 106, which may be superimposed or otherwise encoded with a device and/or account identifier associated with an account registered by a consumer 104 and additional data suitable for use in managing one or more transaction accounts and/or financial products via the processing server 102 using the functions discussed herein.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilizes various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, data identification module 212, generation module 214, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to one or more transaction accounts. Each account profile 208 may include an account identifier associated with a registered transaction account, authentication credentials for accessing the respective transaction account, and information identifying a financial institution 108 associated with the transaction account. The account identifier may be a unique identification value suitable for use in identifying the respective transaction account, such as an identification number. The account identifier may also be the same value included in account credentials, such as a username, email address, identification number, etc. used in the accessing of the respective transaction account. In some instances, the account identifier may be a primary account number for the transaction account. In some embodiments, the account profile 208 may include the primary account number corresponding to a transaction account in addition to the associated account identifier.

In embodiments where the processing server 102 may be configured to manage savings for a transaction account, the account profile 208 may further include additional data related therewith. For instance, the account profile 208 may include a current savings amount, a savings goal, and additional data related to the contribution of additional funds to the savings, such as rules regarding incremental deposits including periods of time and deposit amounts. In cases where the processing server 102 is configured to identify safe spending amounts for a consumer 104, the account profile 208 related to the transaction account for which safe spending is identified may be configured to store data regarding expected sources of income and expected expenses. In some embodiments, such data may be identified by the processing server 102 via transaction data for payment transactions funded via the related transaction account.

The processing server 102 may include a querying module 210. The querying module 210 may be configured to execute queries on databases to identify information. The querying module 210 may receive one or more data values or query strings, and may execute a query string based thereon on an indicated database, such as the account database 206, to identify information stored therein. The querying module 210 may then output the identified information to an appropriate engine or module of the processing server 102 as necessary. The querying module 210 may, for example, execute a query on the account database 206 to identify an account profile 208 related to a request received from a mobile computing device 106 for management of a transaction account, such as a savings request for the establishing or management of savings using the respective transaction account.

The processing server 102 may also include a data identification module 212. The data identification module 212 may be configured to receive one or more data values as input, may identify data based on the input data values, and may output the identified data to another module or engine of the processing server 102. The data identification module 212 may, for example, be configured to identify a starting amount, goal amount, and period of time for use in the management of account savings for a transaction account based on savings data parsed from a savings request received by the receiving device 202 from a mobile computing device 106. For example, the savings request may include a goal savings amount and an indication of a daily contribution and the corresponding amount. The data identification module 212 may be configured to identify the daily contribution as the initial starting amount, may identify the goal amount as is, and may identify a rule for the daily increase of the savings amount by the stated contribution amount. Such data may be provided to the querying module 210 for use in a query to store the data in the account profile 208 associated with the user account. In embodiments where the processing server 102 may be configured to identify safe spending amounts, the data identification module 212 may be configured to identify safe spending amounts using the methods discussed above. In some cases, the data identification module 212 may be configured to identify expected sources of income and expected expenses based on historical transaction behavior for a transaction account, such as by using transaction data stored in a corresponding account profile 208.

The processing server 102 may also include a generation module 214. The generation module 214 may be configured to generate transaction messages for use in performing the functions of the processing server 102. The generation module 214 may receive data for inclusion in a transaction message as input, may generate the transaction message, and may output the generated transaction message to another module or engine of the processing server 102. Transaction messages generated by the generation module 214 may be formatted pursuant to one or more standards, such as the ISO 8583 and ISO 20022 standards, may include message type indicators, and may also include a plurality of data elements configured to store transaction data. In embodiments where the processing server 102 may be used to manage account savings, the generation module 214 may be configured to generate a transaction message used to put an authorization hold on a transaction account, where the transaction message includes a message type indicator indicative of an authorization request and a plurality of data elements including a data element configured to store a primary account number associated with the related transaction account and a data element configured to store the transaction amount to be held, which may be the initial starting amount, an updated amount, or the goal amount. The generation module 214 may also be configured to generate transaction messages that are clearing records to clear a previously generated authorization request, and may include data associated therewith, such as a message type indicator indicative of a clearing record, a data element configured to store a transaction identifier corresponding to the earlier authorization request, etc.

The processing server 102 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks 112 for the transmission of transaction messages that include sensitive financial data and information, such as identified payment credentials. In some instances, the transmitting device 216 may be configured to transmit data to mobile computing devices 106, issuing financial institutions 108, payment networks 112, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to mobile computing devices 106 that are superimposed or otherwise encoded with data suitable for use in the managing of transaction accounts and other financial products registered with the processing server 102, which may be communicated via any suitable communication network and method. For instance, the transmitting device 216 may transmit notifications to the mobile computing device 106 associated with a registered account profile 208 regarding available spending amounts, the status of established savings, the consumer's social impact, etc. The transmitting device 216 may also be configured to transmit data signals to issuing financial institutions 108 that are superimposed or otherwise encoded with account credentials associated with a transaction account issued or otherwise managed by the issuing financial institution 108 and data requests for the access or management of the transaction account as registered by the consumer 104. The transmitting device 216 may also be configured to electronically transmit transaction messages to a payment network 112 via associated payment rails. The transaction messages may be generated by the generation module 214 of the processing server 102 and used in the processing of payment transactions including the establishing and clearing of authorization holds for use in the managing of account savings by the processing server 102.

The processing server 102 may also include a memory 218. The memory 218 may be configured to store data for use by the processing server 102 in performing the functions discussed herein. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein.

### Process for Establishing and Management of Account Savings

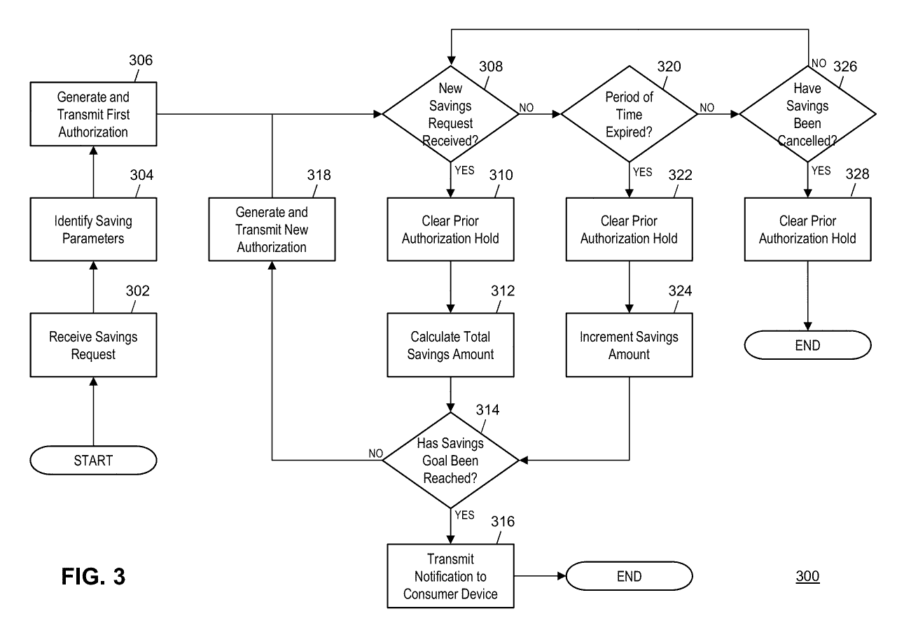

FIG. 3 illustrates a process 300 for the establishing and management of account savings for a transaction account suitable for use in legacy financial systems via the use of authorization holds.

In step 302, a data signal may be received by the receiving device 202 of the processing server 102 that is superimposed or otherwise encoded with a savings request. The savings request may be submitted by a mobile computing device 106 using any suitable communication method or network and may include at least an account identifier and savings data. The savings data may include a starting amount, a goal amount, goal period of time, contribution period of time, contribution rate, name, description, and any other data that may be used in the establishing of account savings and management thereof by a consumer 104. The account identifier may be a primary account number or other data suitable for the identification of a transaction account for which the savings are to be established. In some instances, the savings request may also include authentication information, used to authenticate the originating mobile computing device 106 and/or consumer 104 of the savings request. Methods for authenticating a data submission will be apparent to persons having skill in the relevant art.

In step 304, the querying module 210 of the processing server 102 may execute a query on the account database 206 of the processing server 102 to identify an account profile 208 related to the received savings request. The identified account profile 208 may include an account identifier corresponding to the account identifier included in and parsed from the savings request. In step 306, a first authorization request may be generated and transmitted to establish an authorization hold on the transaction account to establish the account savings. The generation module 214 of the processing server 102 may generate a transaction message that includes a message type indicator indicative of an authorization request and a plurality of data elements including a data element configured to store the primary account number corresponding to the transaction account and a data element configured to store a starting savings amount. The starting savings amount may be included in the savings data parsed from the savings request or may be identified by the data identification module 212 of the processing server 102 based thereon. The transmitting device 216 of the processing server 102 may electronically transmit the transaction message to the payment network 112 via the payment rails associated therewith for processing, which may result in the corresponding issuing financial institution 108 placing an authorization hold on the transaction account for the starting savings amount.

The process 300 may continue with the processing server 102 waiting for any updated instructions to be received with respect to the established account savings. In step 308, the processing server 102 may determine if any new savings requests have been received associated with the established account savings. Savings requests that are associated with the established account savings may include additional data in indication thereof, such as a data value referring to the established account savings, such as an identification number. In some instances, the processing server 102 itself may generate a new savings request, such as following the receipt of transaction data for the transaction account, for which the processing server 102 is to round up for the “deposit” of a corresponding amount in the account savings. If a new savings request is received, then, in step 310, the processing server 102 may clear the prior authorization hold. Clearing of the prior authorization hold may include the generation of a transaction message by the generation module 214 of the processing server 102 that is a clearing record associated with the authorization hold, which may include a data element configured to store a zero transaction amount and a data element configured to store a reference to the prior authorization request, such as a transaction identifier. The clearing record may be electronically transmitted to the payment network 112 by the transmitting device 216 of the processing server 102 via the payment rails associated therewith.

In step 312, the processing server 102 may calculate an updated savings amount. The updated savings amount may be based on the earlier savings amount cleared via the clearing record, which may be the starting savings amount plus any intervening contributions, combined with an additional amount being provided as indicated in the savings request. In step 314, the processing server 102 may determine if the savings goal for the savings has been reached. If the savings goal has been reached (e.g., the updated savings amount meets or exceeds the earlier identified savings goal) then, in step 316, the transmitting device 216 of the processing server 102 may electronically transmit a data signal superimposed or otherwise encoded with a notification to the mobile computing device 106 of the consumer 104 indicating that the goal has been reached. In some instances, the authorization hold may not be renewed, such that the consumer 104 may be able to use the saved up money.

If, in step 314, the processing server 102 determines that the savings goal has not been met, then, in step 318, the generation module 214 of the processing server 102 may generate a new authorization request that includes the updated savings amount in a data element that is submitted to the payment network 112 by the transmitting device 216 of the processing server 102 for placing a new authorization hold on the transaction account for the updated savings amount. The process 300 may return to step 308 to await new savings requests or other updates with respect to the account savings.

If, in step 308, the processing server 102 determines that no new savings request has been received, then the process 300 may proceed to step 320. In step 320, the processing server 102 may determine if a period of time identified for the account savings has expired. The period of time may be a time period indicated in the savings data for automatic contributions to the account savings, such as a daily, weekly, monthly, etc. contribution to the account savings from the transaction account or from one or more alternative transaction accounts. If the time period has expired, then, in step 322, the processing server 102 may clear the prior authorization hold using the same processes described above with respected to step 310. In step 324, the processing server 102 may calculate an updated savings amount by incrementing the previously held amount by the incremental contribution identified via the savings data. The process 300 may then proceed to step 314 to determine if the increment has resulted in the savings achieving the savings goal, with the processing server 102 proceeding accordingly by notifying the consumer 104 or establishing a new, updated authorization hold.

If the authorization hold is updated, then the process 300 may return to steps 308 and 320 to wait for updated savings requests or the expiration of the incremental period of time. If an updated savings request is not received and the time period has not yet expired, then, in step 326, the processing server 102 may determine if a new request has been received from the mobile computing device 106 to cancel the account savings. If no request is received, then the process 300 may continue to await new savings requests, expiration of the time period, or receipt of a cancellation request.

Cancellation requests may be electronically transmitted by the mobile computing device 106 and include the account identifier and/or a reference to the established account savings as well as an indication that the account savings are to be cancelled. If a cancellation request is received by the receiving device 202 of the processing server 102, then, in step 328, the processing server 102 may clear the prior authorization hold on the transaction account using the processes discussed above with respect to step 310. The process 300 may then be completed as the account savings may no longer be established. In some embodiments, the transmitting device 216 of the processing server 102 may electronically transmit a notification to the mobile computing device 106 that indicates that the account savings were successfully cancelled and returned to availability for use.

### Method for Managing Account Savings Via Authorization Holds

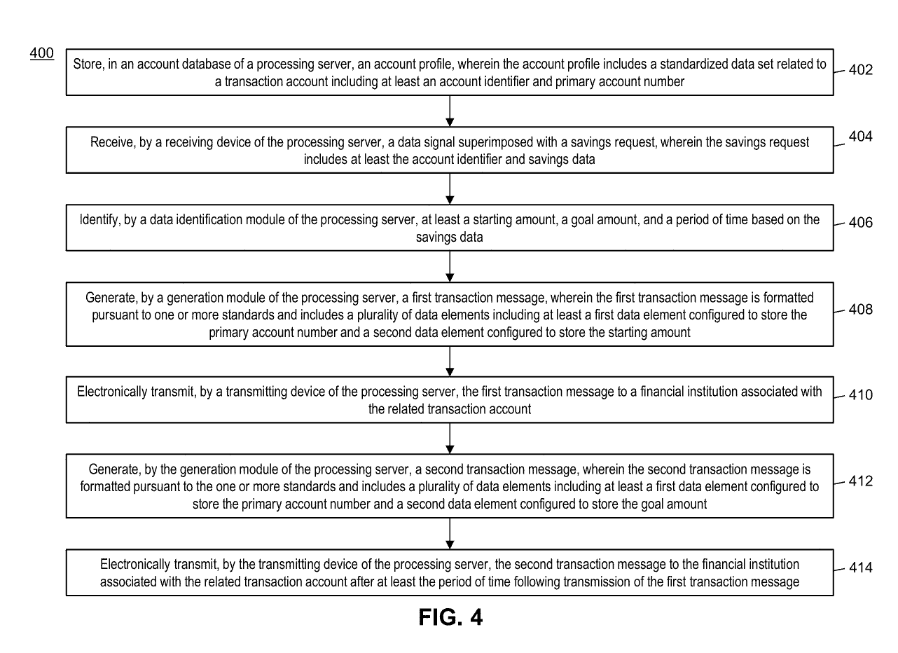

FIG. 4 illustrates a method 400 for the management of account savings in a traditional financial system using authorization holds placed on a transaction account by a third party platform.

In step 402, an account profile (e.g., an account profile 208) may be stored in an account database (e.g., the account database 206) of a processing server (e.g., the processing server 102), wherein the account profile includes a standardized data set related to a transaction account including at least an account identifier and primary account number. In step 404, a data signal superimposed with a savings request may be received by a receiving device (e.g., the receiving device 202) of the processing server, wherein the savings request includes at least the account identifier and savings data.

In step 406, at least a starting amount, a goal amount, and a period of time may be identified by a data identification module (e.g., the data identification module 212) of the processing server based on the savings data. In step 408, a first transaction message may be generated by a generation module (e.g., the generation module 214) of the processing server, wherein the first transaction message is formatted pursuant to one or more standards and includes a plurality of data elements including at least a first data element configured to store the primary account number and a second data element configured to store the starting amount.

In step 410, the first transaction message may be electronically transmitted by a transmitting device (e.g., the transmitting device 216) of the processing server to a financial institution (e.g., the issuing financial institution 108) associated with the related transaction account. In step 412, a second transaction message may be generated by the generation module of the processing server, wherein the second transaction message is formatted pursuant to the one or more standards and includes a plurality of data elements including at least a first data element configured to store the primary account number and a second data element configured to store the goal amount. In step 414, the transmitting device of the processing server may electronically transmit the second transaction message to the financial institution associated with the related transaction account after at least the period of time following transmission of the first transaction message.

In one embodiment, the method 400 may further include: generating, by the generation module of the processing server, one or more intermediate transaction messages, wherein each intermediate transaction message is formatted pursuant to the one or more standards and includes a plurality of data elements including at least a first data element configured to store the primary account number and a second data element configured to store an intermediate amount between the starting amount and the goal amount; and electronically transmitting, by the transmitting device of the processing server, each intermediate transaction message to the financial institution associated with the related transaction account after transmission of the first transaction message and prior to transmission of the second transaction message. In a further embodiment, the intermediate amount included in each of the one or more intermediate transaction messages may be identified by the data identification module of the processing server based on the savings data. In another further embodiment, the savings data may include at least the starting amount, the goal amount, and an incremental period, each intermediate amount included in an intermediate transaction message may be identified based on the starting amount, goal amount, incremental period, and period of time, and each intermediate transaction message may be electronically transmitted after the incremental period following transmission of the first transaction message or another intermediate transaction message.

In some embodiments, the savings data may include at least the starting amount and the goal amount. In one embodiment, the account profile may further include a plurality of transaction data entries, wherein each transaction data entry may include data related to a payment transaction involving the related transaction account including at least a transaction amount and additional transaction data, and the starting amount may be further based on the transaction amount included in at least one transaction data entry included in the account profile. In some embodiments, the one or more standards may include one of: the ISO 8583 standard and the ISO 20022 standard.

In one embodiment, the first transaction message and second transaction message may each further include a message type indicator indicative of an authorization request. In a further embodiment, no settlement or reconciliation message corresponding to the first transaction message or the second transaction message may be electronically transmitted to the financial institution associated with the related transaction account. In some embodiments, the account identifier and primary account number may be the same value.

### Payment Transaction Processing System and Process

FIG. 5 illustrates a transaction processing system and a process 500 for the processing of payment transactions in the system, which may include the processing of thousands, millions, or even billions of transactions during a given period (e.g., hourly, daily, weekly, etc.). The process 500 and steps included therein may be performed by one or more components of the system 100 discussed above, such as the processing server 102, consumers 104, mobile computing devices 106, issuing financial institutions 108, merchants 110, payment network 112, etc. The processing of payment transactions using the system and process 500 illustrated in FIG. 5 and discussed below may utilize the payment rails, which may be comprised of the computing devices and infrastructure utilized to perform the steps of the process 500 as specially configured and programmed by the entities discussed below, including the transaction processing server 512, which may be associated with one or more payment networks configured to processing payment transactions. It will be apparent to persons having skill in the relevant art that the process 500 may be incorporated into the processes illustrated in FIGS. 3 and 4, discussed above, with respect to the step or steps involved in the processing of a payment transaction. In addition, the entities discussed herein for performing the process 500 may include one or more computing devices or systems configured to perform the functions discussed below. For instance, the merchant 506 may be comprised of one or more point of sale devices, a local communication network, a computing server, and other devices configured to perform the functions discussed below.

In step 520, an issuing financial institution 502 may issue a payment card or other suitable payment instrument to a consumer 504. The issuing financial institution may be a financial institution, such as a bank, or other suitable type of entity that administers and manages payment accounts and/or payment instruments for use with payment accounts that can be used to fund payment transactions. The consumer 504 may have a transaction account with the issuing financial institution 502 for which the issued payment card is associated, such that, when used in a payment transaction, the payment transaction is funded by the associated transaction account. In some embodiments, the payment card may be issued to the consumer 504 physically. In other embodiments, the payment card may be a virtual payment card or otherwise provisioned to the consumer 504 in an electronic format.

In step 522, the consumer 504 may present the issued payment card to a merchant 506 for use in funding a payment transaction. The merchant 506 may be a business, another consumer, or any entity that may engage in a payment transaction with the consumer 504. The payment card may be presented by the consumer 504 via providing the physical card to the merchant 506, electronically transmitting (e.g., via near field communication, wireless transmission, or other suitable electronic transmission type and protocol) payment details for the payment card, or initiating transmission of payment details to the merchant 506 via a third party. The merchant 506 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 524, the merchant 506 may enter transaction details into a point of sale computing system. The transaction details may include the payment details provided by the consumer 504 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 506 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 506 may be an online retailer in an e-commerce transaction. In such embodiments, the transaction details may be entered in a shopping cart or other repository for storing transaction data in an electronic transaction as will be apparent to persons having skill in the relevant art.

In step 526, the merchant 506 may electronically transmit a data signal superimposed with transaction data to a gateway processor 508. The gateway processor 508 may be an entity configured to receive transaction details from a merchant 506 for formatting and transmission to an acquiring financial institution 510. In some instances, a gateway processor 508 may be associated with a plurality of merchants 506 and a plurality of acquiring financial institutions 510. In such instances, the gateway processor 508 may receive transaction details for a plurality of different transactions involving various merchants, which may be forwarded on to appropriate acquiring financial institutions 510. By having relationships with multiple acquiring financial institutions 510 and having the requisite infrastructure to communicate with financial institutions using the payment rails, such as using application programming interfaces associated with the gateway processor 508 or financial institutions used for the submission, receipt, and retrieval of data, a gateway processor 508 may act as an intermediary for a merchant 506 to be able to conduct payment transactions via a single communication channel and format with the gateway processor 508, without having to maintain relationships with multiple acquiring financial institutions 510 and payment processors and the hardware associated thereto. Acquiring financial institutions 510 may be financial institutions, such as banks, or other entities that administers and manages payment accounts and/or payment instruments for use with payment accounts. In some instances, acquiring financial institutions 510 may manage transaction accounts for merchants 506. In some cases, a single financial institution may operate as both an issuing financial institution 502 and an acquiring financial institution 510.

The data signal transmitted from the merchant 506 to the gateway processor 508 may be superimposed with the transaction details for the payment transaction, which may be formatted based on one or more standards. In some embodiments, the standards may be set forth by the gateway processor 508, which may use a unique, proprietary format for the transmission of transaction data to/from the gateway processor 508. In other embodiments, a public standard may be used, such as the International Organization for Standardization's ISO 8583 standard. The standard may indicate the types of data that may be included, the formatting of the data, how the data is to be stored and transmitted, and other criteria for the transmission of the transaction data to the gateway processor 508.

In step 528, the gateway processor 508 may parse the transaction data signal to obtain the transaction data superimposed thereon and may format the transaction data as necessary. The formatting of the transaction data may be performed by the gateway processor 508 based on the proprietary standards of the gateway processor 508 or an acquiring financial institution 510 associated with the payment transaction. The proprietary standards may specify the type of data included in the transaction data and the format for storage and transmission of the data. The acquiring financial institution 510 may be identified by the gateway processor 508 using the transaction data, such as by parsing the transaction data (e.g., deconstructing into data elements) to obtain an account identifier included therein associated with the acquiring financial institution 510. In some instances, the gateway processor 508 may then format the transaction data based on the identified acquiring financial institution 510, such as to comply with standards of formatting specified by the acquiring financial institution 510. In some embodiments, the identified acquiring financial institution 510 may be associated with the merchant 506 involved in the payment transaction, and, in some cases, may manage a transaction account associated with the merchant 506.

In step 530, the gateway processor 508 may electronically transmit a data signal superimposed with the formatted transaction data to the identified acquiring financial institution 510. The acquiring financial institution 510 may receive the data signal and parse the signal to obtain the formatted transaction data superimposed thereon. In step 532, the acquiring financial institution may generate an authorization request for the payment transaction based on the formatted transaction data. The authorization request may be a specially formatted transaction message that is formatted pursuant to one or more standards, such as the ISO 8583 standard and standards set forth by a payment processor used to process the payment transaction, such as a payment network. The authorization request may be a transaction message that includes a message type indicator indicative of an authorization request, which may indicate that the merchant 506 involved in the payment transaction is requesting payment or a promise of payment from the issuing financial institution 502 for the transaction. The authorization request may include a plurality of data elements, each data element being configured to store data as set forth in the associated standards, such as for storing an account number, application cryptogram, transaction amount, issuing financial institution 502 information, etc.

In step 534, the acquiring financial institution 510 may electronically transmit the authorization request to a transaction processing server 512 for processing. The transaction processing server 512 may be comprised of one or more computing devices as part of a payment network configured to process payment transactions. In some embodiments, the authorization request may be transmitted by a transaction processor at the acquiring financial institution 510 or other entity associated with the acquiring financial institution. The transaction processor may be one or more computing devices that include a plurality of communication channels for communication with the transaction processing server 512 for the transmission of transaction messages and other data to and from the transaction processing server 512. In some embodiments, the payment network associated with the transaction processing server 512 may own or operate each transaction processor such that the payment network may maintain control over the communication of transaction messages to and from the transaction processing server 512 for network and informational security.

In step 536, the transaction processing server 512 may perform value-added services for the payment transaction. Value-added services may be services specified by the issuing financial institution 502 that may provide additional value to the issuing financial institution 502 or the consumer 504 in the processing of payment transactions. Value-added services may include, for example, fraud scoring, transaction or account controls, account number mapping, offer redemption, loyalty processing, etc. For instance, when the transaction processing server 512 receives the transaction, a fraud score for the transaction may be calculated based on the data included therein and one or more fraud scoring algorithms and/or engines. In some instances, the transaction processing server 512 may first identify the issuing financial institution 502 associated with the transaction, and then identify any services indicated by the issuing financial institution 502 to be performed. The issuing financial institution 502 may be identified, for example, by data included in a specific data element included in the authorization request, such as an issuer identification number. In another example, the issuing financial institution 502 may be identified by the primary account number stored in the authorization request, such as by using a portion of the primary account number (e.g., a bank identification number) for identification.

In step 538, the transaction processing server 512 may electronically transmit the authorization request to the issuing financial institution 502. In some instances, the authorization request may be modified, or additional data included in or transmitted accompanying the authorization request as a result of the performance of value-added services by the transaction processing server 512. In some embodiments, the authorization request may be transmitted to a transaction processor (e.g., owned or operated by the transaction processing server 512) situated at the issuing financial institution 502 or an entity associated thereof, which may forward the authorization request to the issuing financial institution 502.

In step 540, the issuing financial institution 502 may authorize the transaction account for payment of the payment transaction. The authorization may be based on an available credit amount for the transaction account and the transaction amount for the payment transaction, fraud scores provided by the transaction processing server 512, and other considerations that will be apparent to persons having skill in the relevant art. The issuing financial institution 502 may modify the authorization request to include a response code indicating approval (e.g., or denial if the transaction is to be denied) of the payment transaction. The issuing financial institution 502 may also modify a message type indicator for the transaction message to indicate that the transaction message is changed to be an authorization response. In step 542, the issuing financial institution 502 may transmit (e.g., via a transaction processor) the authorization response to the transaction processing server 512.

In step 544, the transaction processing server 512 may forward the authorization response to the acquiring financial institution 510 (e.g., via a transaction processor). In step 546, the acquiring financial institution may generate a response message indicating approval or denial of the payment transaction as indicated in the response code of the authorization response, and may transmit the response message to the gateway processor 508 using the standards and protocols set forth by the gateway processor 508. In step 548, the gateway processor 508 may forward the response message to the merchant 506 using the appropriate standards and protocols. In step 550, assuming the transaction was approved, the merchant 506 may then provide the products purchased by the consumer 504 as part of the payment transaction to the consumer 504.

In some embodiments, once the process 500 has completed, payment from the issuing financial institution 502 to the acquiring financial institution 510 may be performed. In some instances, the payment may be made immediately or within one business day. In other instances, the payment may be made after a period of time, and in response to the submission of a clearing request from the acquiring financial institution 510 to the issuing financial institution 502 via the transaction processing server 502. In such instances, clearing requests for multiple payment transactions may be aggregated into a single clearing request, which may be used by the transaction processing server 512 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 540), the transaction processing server 512 may be configured to perform authorization of transactions on behalf of the issuing financial institution 502. Such actions may be referred to as “stand-in processing,” where the transaction processing server “stands in” as the issuing financial institution 502. In such instances, the transaction processing server 512 may utilize rules set forth by the issuing financial institution 502 to determine approval or denial of the payment transaction, and may modify the transaction message accordingly prior to forwarding to the acquiring financial institution 510 in step 544. The transaction processing server 512 may retain data associated with transactions for which the transaction processing server 512 stands in, and may transmit the retained data to the issuing financial institution 502 once communication is reestablished. The issuing financial institution 502 may then process transaction accounts accordingly to accommodate for the time of lost communication.

In another example, if the transaction processing server 512 is unavailable for submission of the authorization request by the acquiring financial institution 510, then the transaction processor at the acquiring financial institution 510 may be configured to perform the processing of the transaction processing server 512 and the issuing financial institution 502. The transaction processor may include rules and data suitable for use in making a determination of approval or denial of the payment transaction based on the data included therein. For instance, the issuing financial institution 502 and/or transaction processing server 512 may set limits on transaction type, transaction amount, etc. that may be stored in the transaction processor and used to determine approval or denial of a payment transaction based thereon. In such instances, the acquiring financial institution 510 may receive an authorization response for the payment transaction even if the transaction processing server 512 is unavailable, ensuring that transactions are processed and no downtime is experienced even in instances where communication is unavailable. In such cases, the transaction processor may store transaction details for the payment transactions, which may be transmitted to the transaction processing server 512 (e.g., and from there to the associated issuing financial institutions 502) once communication is reestablished.

In some embodiments, transaction processors may be configured to include a plurality of different communication channels, which may utilize multiple communication cards and/or devices, to communicate with the transaction processing server 512 for the sending and receiving of transaction messages. For example, a transaction processor may be comprised of multiple computing devices, each having multiple communication ports that are connected to the transaction processing server 512. In such embodiments, the transaction processor may cycle through the communication channels when transmitting transaction messages to the transaction processing server 512, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 510 may identify that an authorization request involves an issuing financial institution 502 (e.g., via the bank identification number included in the transaction message) for which no value-added services are required. The transaction processor at the acquiring financial institution 510 may then transmit the authorization request directly to the transaction processor at the issuing financial institution 502 (e.g., without the authorization request passing through the transaction processing server 512), where the issuing financial institution 502 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 512 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 508, acquiring financial institution 510, etc.) for processing using this advanced network, and to quickly and efficiently receive a response regarding the ability for a consumer 504 to fund the payment transaction.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for managing account savings via authorization holds. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for managing account savings via authorization holds, comprising:
storing, in an account database of a processing server, an account profile, wherein the account profile includes a standardized data set related to a transaction account including at least an account identifier and primary account number;
receiving, by a receiving device of the processing server, a data signal superimposed with a savings request, wherein the savings request includes at least the account identifier and savings data;
identifying, by a data identification module of the processing server, at least a starting amount, a goal amount, and a period of time based on the savings data;
generating, by a generation module of the processing server, a first transaction message, wherein the first transaction message is formatted pursuant to one or more standards and includes a plurality of data elements including at least a first data element configured to store the primary account number and a second data element configured to store the starting amount;
electronically transmitting, by a transmitting device of the processing server, the first transaction message to a financial institution associated with the related transaction account;
generating, by the generation module of the processing server, a second transaction message, wherein the second transaction message is formatted pursuant to the one or more standards and includes a plurality of data elements including at least a first data element configured to store the primary account number and a second data element configured to store the goal amount; and
electronically transmitting, by the transmitting device of the processing server, the second transaction message to the financial institution associated with the related transaction account after at least the period of time following transmission of the first transaction message.

2. The method of claim 1, further comprising:
generating, by the generation module of the processing server, one or more intermediate transaction messages, wherein each intermediate transaction message is formatted pursuant to the one or more standards and includes a plurality of data elements including at least a first data element configured to store the primary account number and a second data element configured to store an intermediate amount between the starting amount and the goal amount; and
electronically transmitting, by the transmitting device of the processing server, each intermediate transaction message to the financial institution associated with the related transaction account after transmission of the first transaction message and prior to transmission of the second transaction message.

3. The method of claim 2, wherein the intermediate amount included in each of the one or more intermediate transaction messages is identified by the data identification module of the processing server based on the savings data.

4. The method of claim 2, wherein
the savings data includes at least the starting amount, the goal amount, and an incremental period,
each intermediate amount included in an intermediate transaction message is identified based on the starting amount, goal amount, incremental period, and period of time, and
each intermediate transaction message is electronically transmitted after the incremental period following transmission of the first transaction message or another intermediate transaction message.

5. The method of claim 1, wherein the savings data includes at least the starting amount and the goal amount.

6. The method of claim 1, wherein
the account profile further includes a plurality of transaction data entries, wherein each transaction data entry includes data related to a payment transaction involving the related transaction account including at least a transaction amount and additional transaction data, and
the starting amount is further based on the transaction amount included in at least one transaction data entry included in the account profile.

7. The method of claim 1, wherein the first transaction message and second transaction message each further include a message type indicator indicative of an authorization request.

8. The method of claim 7, wherein no settlement or reconciliation message corresponding to the first transaction message or the second transaction message is electronically transmitted to the financial institution associated with the related transaction account.

9. The method of claim 1, wherein the account identifier and primary account number are the same value.

10. The method of claim 1, wherein the one or more standards includes one of: the ISO 8583 standard and the ISO 20022 standard.

11. A system for managing account savings via authorization holds, comprising:
an account database of a processing server configured to store an account profile, wherein the account profile includes a standardized data set related to a transaction account including at least an account identifier and primary account number;
a receiving device of the processing server configured to receive a data signal superimposed with a savings request, wherein the savings request includes at least the account identifier and savings data;
a data identification module of the processing server configured to identify at least a starting amount, a goal amount, and a period of time based on the savings data;
a generation module of the processing server configured to generate a first transaction message, wherein the first transaction message is formatted pursuant to one or more standards and includes a plurality of data elements including at least a first data element configured to store the primary account number and a second data element configured to store the starting amount; and
a transmitting device of the processing server configured to electronically transmit the first transaction message to a financial institution associated with the related transaction account, wherein
the generation module of the processing server is further configured to generate a second transaction message, wherein the second transaction message is formatted pursuant to the one or more standards and includes a plurality of data elements including at least a first data element configured to store the primary account number and a second data element configured to store the goal amount, and
the transmitting device of the processing server is further configured to electronically transmit the second transaction message to the financial institution associated with the related transaction account after at least the period of time following transmission of the first transaction message.

12. The system of claim 11, wherein
the generation module of the processing server is further configured to generate one or more intermediate transaction messages, wherein each intermediate transaction message is formatted pursuant to the one or more standards and includes a plurality of data elements including at least a first data element configured to store the primary account number and a second data element configured to store an intermediate amount between the starting amount and the goal amount, and
the transmitting device of the processing server is further configured to electronically transmit each intermediate transaction message to the financial institution associated with the related transaction account after transmission of the first transaction message and prior to transmission of the second transaction message.

13. The system of claim 12, wherein the intermediate amount included in each of the one or more intermediate transaction messages is identified by the data identification module of the processing server based on the savings data.

14. The system of claim 12, wherein
the savings data includes at least the starting amount, the goal amount, and an incremental period,
each intermediate amount included in an intermediate transaction message is identified based on the starting amount, goal amount, incremental period, and period of time, and
each intermediate transaction message is electronically transmitted after the incremental period following transmission of the first transaction message or another intermediate transaction message.

15. The system of claim 11, wherein the savings data includes at least the starting amount and the goal amount.

16. The system of claim 11, wherein
the account profile further includes a plurality of transaction data entries, wherein each transaction data entry includes data related to a payment transaction involving the related transaction account including at least a transaction amount and additional transaction data, and
the starting amount is further based on the transaction amount included in at least one transaction data entry included in the account profile.

17. The system of claim 11, wherein the first transaction message and second transaction message each further include a message type indicator indicative of an authorization request.

18. The system of claim 17, wherein no settlement or reconciliation message corresponding to the first transaction message or the second transaction message is electronically transmitted to the financial institution associated with the related transaction account.

19. The system of claim 11, wherein the account identifier and primary account number are the same value.

20. The system of claim 11, wherein the one or more standards includes one of: the ISO 8583 standard and the ISO 20022 standard.
